(19) United States
(12) Patent Application Publication
(10) Pub. No.: US 2026/0160620 A1
(43) Pub. Date: Jun. 11, 2026

(54) METHOD AND SYSTEM FOR JOINT MONITORING OF NON-DISPERSIVE FREQUENCY BAND AND MECHANICAL TENSION IN STRUCTURES

(71) Applicant: SERCEL, Carquefou (FR)

(72) Inventor: Viktor SMIRNOV, Carquefou (FR)

(21) Appl. No.: 18/969,869

(22) Filed: Dec. 5, 2024

(51) Int. Cl. G01L 5/04; G01V 1/38

(52) U.S. Cl. CPC G01L 5/042; G01V 1/3843

(57) ABSTRACT

A method for jointly estimating a tension T and a critical frequency f_{c} in a tensionable element, includes measuring, with plural particle motion sensors, data associated with waves that propagate along the tensionable element; applying a low-pass filtering to the data, in a non-dispersive frequency band [0, f_{c}], to calculate a phase velocity of the wave; estimating the tension T in the tensionable element based on the phase velocity of the wave; calculating the critical frequency f_{c} corresponding to the tension T based on a model which links the critical frequency to the tension; and repeating the steps of applying, estimating, and calculating until a difference between a previous tension T or a previous critical frequency f_{c} and a current tension Tor a current critical frequency f_{c}, respectively, is smaller than a given threshold value.

### BACKGROUND

### Technical Field

Embodiments of the subject matter disclosed herein generally relate to methods and systems for parameter monitoring of a device under tension and, more particularly, to a new approach for jointly estimating a critical frequency and the tension in the device, for a non-dispersive band, when the device experiences the tension. Such an approach provides a more accurate tension estimation, which is useful for any device under tension, as the device may fail if the tension exceeds a certain value.

### Discussion of the Background

Today, many structures (e.g., bridges, masts, tower cables, multi-component streamers, etc.) include one or more elements (e.g., cables, beams, ropes, plates, or similar structures, generically called herein “tensionable element” or “element”) that experience continuous or alternating stress (e.g., tension, compression, shear, bending, torsion). Although these elements are designed to withstand such stress, early fatigue or defects in the elements may cause them to fail, which is not only unsafe for humans, but also costly for the economy. Thus, monitoring the tension in one or more elements of such structures is important for preventing failure and implicitly human injury.

For example, if the structure is a bridge, its cables play a significant role in the load-bearing capacity and stability of it. Proper tension ensures that the bridge can support the weight of traffic, pedestrians, and any other loads it may encounter. Monitoring tension helps identify potential weaknesses or anomalies that could compromise the structural integrity of the bridge. In terms of safety, a bridge failure can have catastrophic consequences, leading to loss of life and property damage. Monitoring tension helps ensure that the bridge remains within safe operational limits, and any potential issues can be detected early on to prevent accidents. From a load distribution point of view, bridges experience varying loads throughout their lifespan due to traffic patterns, environmental factors, and construction work. Monitoring tension helps engineers and authorities understand how the loads are distributed among the cables and other structural components. This knowledge allows them to take appropriate actions to redistribute loads or make necessary repairs.

In addition, the environmental factors have an effect on the structure of the bridge. Environmental conditions like temperature changes, humidity, wind, and seismic activity can affect the tension in bridge cables. Monitoring tension helps understand how these factors impact the structural behavior and allows for adjustments and maintenance as needed. Regular tension monitoring is also part of a comprehensive maintenance strategy. By identifying and addressing potential cable issues early on, costly repairs or replacements can be avoided, prolonging the bridge's lifespan and reducing long-term maintenance expenses. Monitoring tension provides valuable data for engineers to assess the bridge's performance over time. This data is useful for designing new bridges or upgrading existing ones to improve their load-carrying capacity and overall safety. In many jurisdictions, bridge owners are required to monitor and maintain bridges within certain safety standards. Monitoring tension ensures compliance with these regulations and helps meet safety standards set by engineering organizations. Overall, tension monitoring is a critical part of bridge maintenance and management, ensuring safety, extending the bridge's service life, and providing valuable data for future design and upgrades.

Although the example above referred specifically to a bridge, the same or similar considerations may apply to other structures, for example, masts, towers cables (e.g., radio towers cables), industrial chimney cables, lift gate counterweights, hoist cables for river control structures, cable stayed buildings, in particular stadiums (suspension domes), risers in the oil and gas industry, rails, catenaries for dispensing electricity, cables which are put under tension due to pulling, etc.

There are several methods to monitor the tension in a cable of a bridge (or similar structures), each with its own advantages and limitations. Some common techniques include applying load cells or strain gauges on the cables. Load cells or strain gauges are devices that can be attached directly to the cables. They measure the strain or deformation in the cable as loads are applied. By calibrating the readings, engineers can determine the tension in the cable. Vibration-based methods, which is another technique, rely on monitoring the natural frequency and vibrations of the bridge cables. Changes in tension can cause shifts in the natural frequencies, which can be detected through accelerometers or other vibration sensors. Acoustic Emission (AE) testing is another non-destructive testing method that involves listening for acoustic signals emitted by wire breaks, which may lead to loss of tension. However, this technique is prone to false alarms. Remote sensing techniques use remote sensing technologies like LiDAR (Light Detection and Ranging) or laser-based measurements to monitor the deflection and movement of bridge cables, which can be related to cable tension. Fiber optic sensors can be embedded within the bridge cables to measure strain and temperature changes. These sensors offer high accuracy and real-time monitoring capabilities. Another approach is the use of distributed sensing systems, which use a network of sensors along the entire length of the cable to provide continuous and detailed tension monitoring.

While the current methods for monitoring tension in bridge cables are effective and valuable, they do have some limitations that engineers and researchers need to consider. One such limitation is the cost. Some monitoring techniques can be expensive to implement, especially if they require specialized equipment or sensors to be retrofitted onto existing bridge structures. The initial setup and ongoing maintenance costs can be significant. Bridges can be challenging to access, especially for large or long-span structures. Monitoring systems may require workers to access elevated areas or even work over water, posing safety risks and logistical challenges. Achieving high accuracy in tension measurements can be challenging, particularly with strain gauges or load cells. Proper calibration and regular maintenance are necessary to ensure accurate and reliable data. Environmental conditions such as temperature, humidity, and wind can influence the accuracy of some monitoring techniques. For example, changes in temperature can affect the readings of strain gauges and acoustic emission sensors. The placement of sensors on bridge cables is critical to obtaining meaningful data. Insufficient coverage or improper sensor placement can lead to incomplete or misleading tension readings. The data collected from monitoring systems require interpretation by experienced engineers. Analyzing the data, distinguishing between normal variations and potential issues, and making informed decisions based on the results can be complex. Monitoring systems themselves require regular maintenance to ensure they remain operational and provide accurate data. Malfunctions or failures of sensors or data transmission systems can lead to gaps in monitoring and data loss. All these requirements place a high burden on the task of monitoring the structure and also may become very expensive to run.

Thus, there is a need to provide a method that accurately estimates the tension in a cable, with low cost, and minimum changes to the existing structures.

### SUMMARY OF THE INVENTION

According to an embodiment, there is a method for jointly estimating a tension T and a critical frequency f_{c} in a tensionable element. The method includes measuring with plural particle motion sensors data associated with waves that propagate along the tensionable element, applying a low-pass filtering to the data, in a non-dispersive frequency band [0, f_{c}], to calculate a phase velocity of the wave, estimating the tension T in the tensionable element based on the phase velocity of the wave, calculating the critical frequency f_{c} corresponding to the tension T based on a model which links the critical frequency to the tension, and repeating the steps of applying, estimating, and calculating until a difference between a previous tension T or a previous critical frequency f_{c} and a current tension T or a current critical frequency f_{c}, respectively, is smaller than a given threshold value. The critical frequency f_{c} defines a border between the non-dispersive frequency band and a dispersive frequency band of the tensionable element.

According to another embodiment, there is a computing device for jointly estimating a tension T and a critical frequency f_{c} in a tensionable element. The computing device includes an interface for receiving data measured with plural particle motion sensors along the tensionable element, wherein the data is associated with waves that propagate along the tensionable element, and a processor connected to the interface and configured to apply a low-pass filtering to the data, in a non-dispersive frequency band [0, f_{c}], to obtain a phase velocity of the wave, estimate the tension Tin the tensionable element based on the phase velocity of the wave, calculate the critical frequency f_{c} corresponding to the tension T based on a model which links the critical frequency to the tension, and repeat the steps of applying, estimating, and calculating until a difference between a previous tension T or a previous critical frequency f_{c} and a current tension T or a current critical frequency f_{c}, respectively, is smaller than a given threshold value. The critical frequency f_{c} defines a border between the non-dispersive frequency band and a dispersive frequency band of the tensionable element.

According to yet another embodiment, there is a streamer to be towed in water for collecting seismic data. The streamer includes a body, plural particle motion sensors located inside the body, and a computing device located inside the body. The computing device includes an interface for receiving data measured with plural particle motion sensors along the tensionable element, wherein the data is associated with waves that propagate along the tensionable element, and a processor connected to the interface and configured to apply a low-pass filtering to the data, in a non-dispersive frequency band [0, f_{c}], to calculate a phase velocity of the wave, estimate the tension T in the tensionable element based on the phase velocity of the wave, calculate the critical frequency f_{c} corresponding to the tension T based on a model which links the critical frequency to the tension, and repeat the steps of applying, estimating, and calculating until a difference between a previous tension T or a previous critical frequency f_{c} and a current tension Tor a current critical frequency f_{c}, respectively, is smaller than a given threshold value. The critical frequency f_{c} defines a border between the non-dispersive frequency band and a dispersive frequency band of the tensionable element.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a marine seismic acquisition system;

FIG. 2 illustrates dispersive wave packets moving with different group and phase velocities along a cable;

FIG. 3 illustrates the phase velocity versus frequency for different tension values applied to a streamer;

FIG. 4 illustrates phase velocities versus frequency according to a new model;

FIGS. 5A and 5B schematically illustrate methods for jointly calculating a critical frequency and a tension in the streamer based on the new model;

FIG. 6 illustrates a bridge having sensors distributed on one or more cables;

FIG. 7A illustrates a computing device for calculating a tension in a streamer;

FIG. 7B illustrates an antenna having plural particle motion sensors and the computing device of FIG. 7A; and

FIG. 8 is a flowchart of a method for jointly calculating a tension along a tensionable element and an associated critical frequency that defines a non-dispersive frequency band.

### DETAILED DESCRIPTION

The following description of the embodiments refers to the accompanying drawings. The same reference numbers (except the first digit) in different drawings identify the same or similar elements. The following detailed description does not limit the invention. Instead, the scope of the invention is defined by the appended claims. The following embodiments are discussed, for simplicity, with regard to the terminology and structure of a streamer towed in water by a vessel. However, the embodiments to be discussed next are not limited to a marine streamer; they may be applied to other seismic elements that are towed in water, for example, an antenna or any cable that hosts particle motion sensors, or to elements that are not towed in water, for example, to a bridge or to any commercial, industrial or residential structures that have elements that experience stress, as discussed in the Background section. In particular, the embodiments discussed herein may be used for those applications where sensors might not be the core of the product, and the particle motion sensors discussed herein can be replaced by any type of sensor: accelerometer, geophone, optical fiber, etc., and the transmission of the collected data might be wireless or through cable.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, there is a tensionable element (e.g., streamer, antenna, cable, beam, rope, catenary, plate, etc.) that includes sensors (e.g., seismic sensors, displacement sensors, accelerometers, etc.) capable of measuring a quantity (e.g., speed, displacement, or acceleration) indicative of a particle motion of the element. Based on information recorded by the sensors, the tensile load in the element may be calculated jointly with a non-dispersive frequency band as long as there is a model that relates the wave velocity with the tensile load in the element. This method can be applied both to transverse and longitudinal vibration waves. In the following, this method is illustrated for a streamer that is towed in water by a vessel and thus, there are transverse vibration waves in the streamer.

One advantage of such streamer is that the tensile load information along the streamer can be calculated without the need of any additional tensile load sensor. In other words, the particle motion sensors that are typically used in a streamer for collecting seismic data may also be used, as will be discussed next, to calculate the tensile load along the streamer. Thus, during seismic acquisition, this streamer may be used to find the tensile load (or tension) along the streamer, to find the location of a floating object (e.g., fishing net) caught in the streamer (or bird) as a discontinuity in the curve corresponding to the tension versus length of the streamer. The tension in the streamer may be calculated when the streamer records seismic data or not. During deployment or retrieval, the method may be used to monitor the tension in the part of the streamer that is still in water. Knowing the tensile load in the streamer during deployment and/or retrieval is also useful for determining the winding/unwinding speed of the streamer. Thus, with the method to be discussed next, the winding speed of the streamer (or drum) can be controlled (adjusted) depending on the measured tensile load. According to an embodiment, the novel method of measuring the tensile load along the streamer achieves these results without any dedicated tensile load sensor or module.

For exemplifying the novel method, a seismic data acquisition system is first introduced. This system is typically used for geophysical exploration to determine the properties of a portion of the earth's subsurface, information that is especially helpful for determining the location of underground deposits (e.g., oil, gas, etc.). Marine reflection seismology is based on the use of a controlled source that sends energy waves into the earth. By measuring the time it takes for the reflections to come back to plural receivers, it is possible to estimate the depth and/or composition of the features causing such reflections. These features may be associated with the underground deposits.

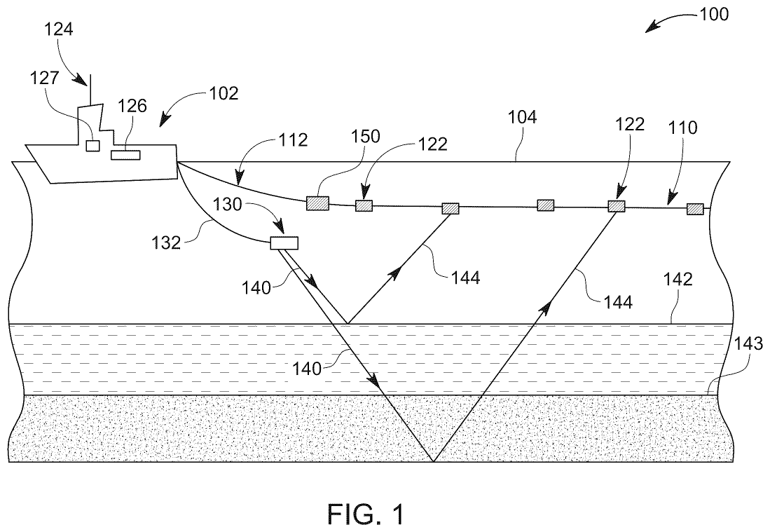

A seismic survey system 100, as illustrated in FIG. 1, includes a vessel 102 that tows plural streamers 110 (only one is shown in the figure) and a seismic source 130, below the water surface 104. Streamer 110 is attached through a lead-in cable (or other cables) 112 to vessel 102, while source array 130 is attached through an umbilical 132 to the vessel. Sensors (for example, seismic receivers) 122 are distributed along the streamer 110 and are configured to record seismic data. Sensors 122 may include a hydrophone, geophone, accelerometer, gradient pressure receiver or a combination thereof.

During operation, vessel 102 follows a predetermined path while source 130, which may include plural elements, emits seismic waves 140. These waves bounce off the ocean bottom 142 and other layer interfaces 143, below the ocean bottom 142, and propagate as reflected/refracted waves 144 that are recorded by receivers 122. The positions of both the source 130 and sensors 122 are estimated based on GPS systems 124 and recorded together with the seismic data in a storage device 127, onboard the vessel. A controller 126 has access to the seismic data and may be used to achieve quality control or even full processing of this data. Controller 126 may be also connected to the vessel's navigation system and other elements of the seismic survey system. Parts of the controller 126 (for example a processor and a memory unit) may be located within the streamer 110.

During the seismic acquisition process, the tensile loads of the towed seismic streamers have to be monitored, especially during deployment and retrieval operations. This is so because a higher tensile load on the streamer may rupture or damage or break the streamer. Currently, the tensile load is measured by an in-line tensile module 150, which is inserted between the lead-in 112 and the streamer 110. The in-line tensile module 150 includes a tensile load sensor that can measure the tensile load generated by towing the entire streamer in water. However, this module allows measuring the tensile load only in one location of the streamer and not along the streamer. In this regard, note the tension in the streamer varies along its length.

A novel method for determining the tensile load in a towed seismic streamer, at any point along the streamer, is now discussed with regard to a method disclosed in [1]. The tensile load is a function of the inline offset (distance between vessel or streamer's head and the point where the tension is calculated) or streamer length x. The tensile load can be expressed as a sum of the drag forces exerted on the body of the streamer, the drag forces exerted on a buoy that holds the streamer at a given depth in the water, and the drag forces exerted on any device attached to the body of the streamer. Measurements of the tension along the streamer reveal that the tension has a quasi-linear distribution along the streamer.

Seismic streamers are subject to several modes of vibration due to the action of ocean surface waves, tugging, external devices, current, etc. The particle motion sensors distributed in the streamers are sensitive enough to pick up these vibration noises. Typical modes of vibration include longitudinal vibrations, transverse vibrations and angular vibrations. The transverse vibrations are most dominant, i.e., larger amplitude, and for this reason, as will be discussed next, this type of vibration is considered in further calculations.

The method of [1] proposes to use the relationship between the phase velocity of transverse waves and the mechanical tension to estimate it. Indeed, for a non-dispersive wave, the phase velocity is equal to the group velocity. In this regard, note that for a wave that includes plural packets, each having a different frequency, each packet travels along the streamer (or other medium) with a velocity (phase velocity) that is dependent on the frequency (the phase) of the packet. However, the plural packets are considered to travel together with a group velocity, which is given by the envelope of the group, and which in general is different from the phase velocity. Unlike the phase velocity, the group velocity can be easily estimated from the data (for example by using correlation between sensors whose spacing is known).

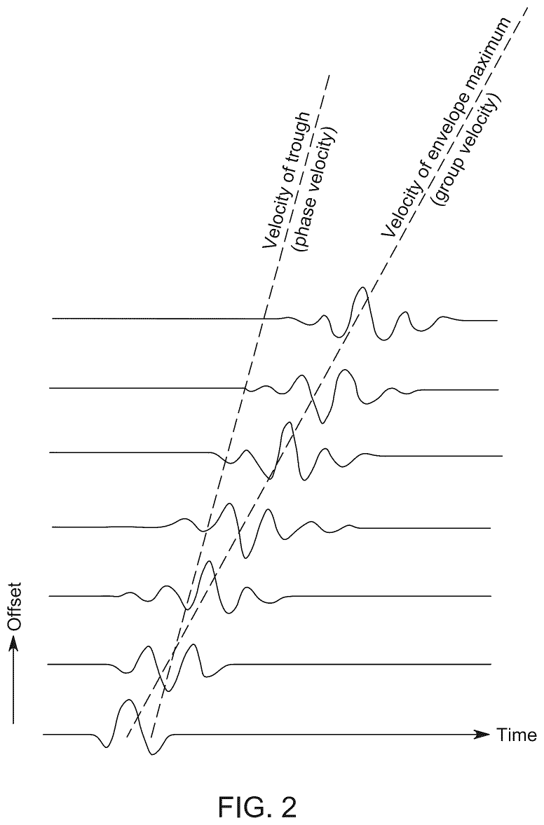

However, most often the wave packets propagating on cables are dispersive (i.e., all the frequencies do not travel at the same velocity) and one cannot consider the phase velocity as equal to the group velocity, as shown in FIG. 2 (which is reproduced from A. Balch and F. Smolka, 1970, Plane and Spherical Transient Voigt Waves, Geophysics, 35:745-761). The wave in this figure is dispersive because the wavelet is distorted during the propagation as all the frequencies that compose the wavelet do not travel at the same speed. If one estimates the velocity of this wave using correlation, the velocity of the envelope is obtained, i.e., the group velocity. However, the velocity of interest is the phase velocity, because it is for this velocity that there is a model that allows to connect it to the mechanical tension in the streamer. In other words, the sensors along the streamer are useful for measuring the group velocity while the existing models of the streamers use the phase velocity. If the waves that propagate along the streamer are dispersive, i.e., each packet travels with a different velocity, then the phase velocity is different from the group velocity and thus, if the existing models are used with the measured velocities, they will generate inaccurate tensions.

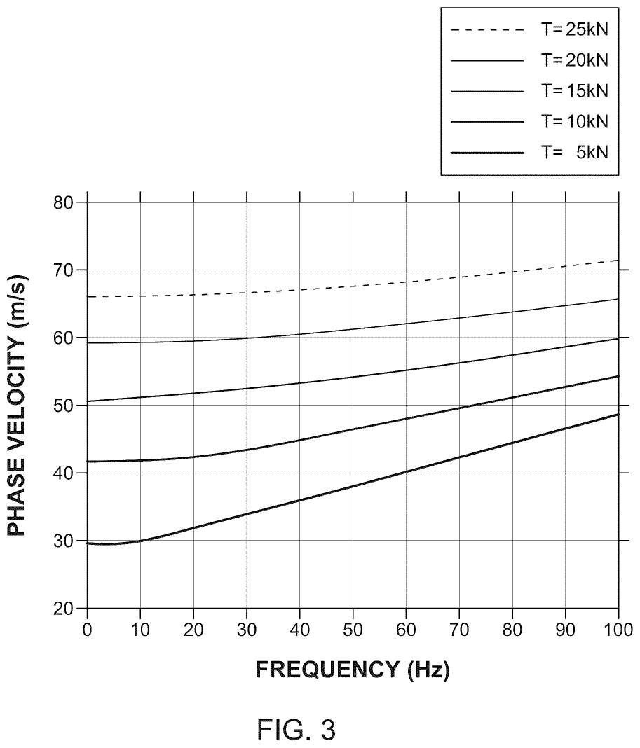

To overcome this problem, the authors in [1] proposed to consider a non-dispersive frequency band within the two velocities are equal and thus, to use the measured group velocity for this band, which is equal to the phase velocity. In this regard, FIG. 3 (reproduced from [1]) shows that the high frequencies are traveling faster than the low frequencies. However, one can see that the phase velocity could be approximated to be a constant in the very low frequencies range (e.g., below 15 Hz). This approximation provides good practical results. However, [1] is silent on the actual choice of this band (i.e., 0-15 Hz), or how to select an appropriate band for another structure (i.e., bridge instead of a streamer). In other words, there is a need for determining in a more precise way a non-dispersive frequency band for which the group velocity is considered to be equal to the phase velocity, which would allow a more accurate estimation of the tension in the tensionable elements, be it a streamer, a bridge cable or any other cable.

For the bridge situation, for obvious safety reasons, the tension of cables in cable-stayed bridges is regularly measured, or monitored. One disclosed solution for the estimation of mechanical stress concerns the use of a model between the wave velocity and mechanical configuration, as in, for example, in [2]. However, this method also fails to provide an accurate and exact mechanism for selecting the non-dispersive frequency band.

According to an embodiment, a mechanism for the selection of the non-dispersive frequency band is now discussed. This estimation of the non-dispersive frequency band of propagating waves allows improved estimation of mechanical tension along the streamer or any other element in the structures noted above as the phase velocity used in the velocity-tension model is substantially equal to the measured group velocity. The non-dispersive frequency band is considered to extend from zero to a critical frequency f_{c} and thus, the novel method determines f_{c}. In one application, the method jointly determines the frequency f_{c} up to which waves are non-dispersive and the mechanical tension T of the streamer along which waves propagate. The method is applicable to any element of a structure that experiences stress. As noted above, the method is implemented for the streamer in a marine seismic survey system but the method is not limited to this application. One skilled in the art would understand, based on the following description, how to extend this method to any cable that has two or more sensors for measuring a group velocity.

The use of this critical frequency allows to reach the non-dispersive band for which a model connecting the mechanical tension and velocity is available. Thus, this frequency allows a better estimation of the mechanical tension. This frequency being itself dependent of the mechanical tension, the estimation of the critical frequency and the tension are successively performed until convergence is achieved, where a robust estimation of the mechanical tension and f_{c} is obtained.

The choice of the non-dispersive band is not obvious since, as shown in FIG. 3, the frequency up to which the phase velocity can be considered approximately constant varies with the tension, up to about 20 Hz at 25 kN versus up to about 5 Hz at 5 kN. The frequency band to be considered varies according to the tension, but it is this tension that is desired to be estimated and which is therefore unknown. A solution would be to use a short frequency band (e.g., up to 5 Hz) to ensure that the waves are non-dispersive for the tensions involved. However, estimating the phase velocity over such a short frequency band would be subject to a very large uncertainty that would affect the final estimate of the mechanical tension.

The method discussed herein relies on the Euler-Bernoulli equation describing a transverse motion of a cable in water that is towed along an axial direction of the cable with constant water speed U₀. The equation is used to approximate the transverse vibrations that propagate in the cable (see [3] for more details), and it is as follows:

$$EI \frac{{\partial }^{4} u ( x , t )}{\partial {x}^{4}} - T \frac{{\partial }^{2} u ( x , t )}{\partial {x}^{2}} + \frac{π {d}^{2} {ρ}_{S}}{4} \frac{{\partial }^{2} u ( x , t )}{\partial {t}^{2}} = {f}_{m} ( x , t ) + h ( x , t ) , \qquad ( 1 )$$

where tis the time, x is the inline axis, u(x, t) is the transverse displacement, E is the Young modulus of the cable, I is the area moment of inertia, m is the mass per unit length of the streamer, Tis the axial tension due to the towing vessel, dis the streamer diameter, ρ_{S} is the streamer density, fₘ(x, t) is the inertial force, and h(x, t) is the external force per unit of length exerted on a portion of the cable by the ambient. The product EI is called herein the flexural rigidity.

Considering that the inertial force fₘ(x, t) corresponds only to the acceleration of the fluid displaced by the body of the streamer, i.e.,

$${f}_{m} ( x , t ) = - \frac{π {d}^{2} {ρ}_{w}}{4} \frac{{\partial }^{2} u ( x , t )}{\partial {t}^{2}} ,$$

where ρ_{w} is the density of the water, and no external forces are present, the following phase velocity is obtained for the waves that transversally propagate through the streamer:

$${v}_{p} ( k ) ≡ \frac{f ( k )}{k} = \pm \frac{2}{d} \sqrt{\frac{T + 4 {π}^{2} {k}^{2} EI}{π ( {ρ}_{s} + {ρ}_{w} )}} , \qquad ( 2 )$$

where the sign±gives the direction of the wave, e.g., head-to-tail is downgoing and tail-to-head is upgoing. This relationship correctly reflects the dispersive nature of the transverse wave velocity that is observed in the field data. Equation (2) does not explain the velocity difference observed between a wave that travels from the head of the streamer to its tail, and a wave that travels the opposite direction.

To account for this difference, the authors in [3] used a new expression for the inertial force fₘ(x, t), i.e.,

$${f}_{m} ( x , t ) = - \frac{π {d}^{2} {ρ}_{w}}{4} ( \frac{{\partial }^{2} u ( x , t )}{\partial {t}^{2}} + {U}_{0}^{2} \frac{{\partial }^{2} u ( x , t )}{\partial {t}^{2}} + 2 {U}_{0} \frac{{\partial }^{2} u ( x , t )}{\partial t \partial x} ) , \qquad ( 3 )$$

where U₀ is the water-speed, i.e., the speed of the streamer relative to the water. Based on equation (3), a new expression is obtained for the velocity of the transverse waves:

$${v}_{p} ( k ) ≡ \frac{f ( k )}{k} = \frac{{U}_{0}}{2} \pm \frac{2}{d} \sqrt{\frac{4 {π}^{2} {k}^{2} EI + T \frac{π ( {ρ}_{s} + {ρ}_{w} ) {d}^{2} {U}_{0}^{2}}{16}}{π ( {ρ}_{s} + {ρ}_{w} )}} , \qquad ( 4 )$$

where ρₛ is the density of the streamer (cable).

This new model fits the transverse wave velocity (4) better than the pre-existing models. In particular, the phase velocity vₚ(ω, x) of the transverse waves at position x and pulsation ω=2πf (f frequency of the transverse wave) can be written as:

$${v}_{p} ( ω , x ) = \pm c . γ - \frac{{U}_{0}}{2} , \qquad ( 5 )$$

with

$$c ( x ) = \sqrt{\frac{T ( x )}{2 σ}} , \qquad ( 6 )$$

$$γ ( ω , x ) = \sqrt{\frac{1}{2} ( 1 + \sqrt{1 + \frac{8 EI {σω}^{2}}{{T ( x )}^{2}}} )} , \qquad ( 7 )$$

with c being the non-dispersive velocity, T(x) being the mechanical tension at position x, and σ being the mass of the streamer per unit of length.

The ±sign is used to express the difference in velocity between the waves propagating in the two directions of the cable (towards the head and tail). In this regard, the velocity of the wave propagating in the towing direction is given by:

$${v}_{p , -} ( ω , x ) = - c . γ - \frac{{U}_{0}}{2} , \qquad ( 8 )$$

and the velocity of the wave propagating in the opposite direction is given by:

$${v}_{p , +} ( ω , x ) = + c . γ - \frac{{U}_{0}}{2} . \qquad ( 9 )$$

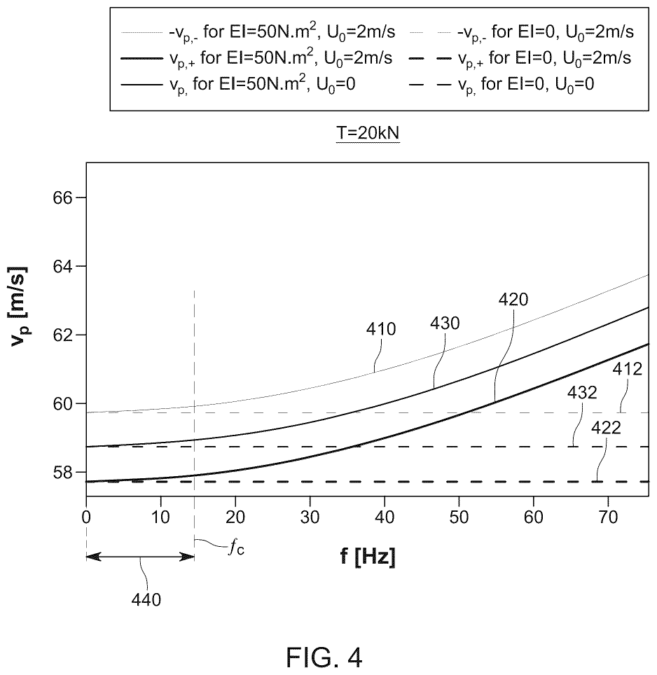

If the phase velocities (toward the head and toward the tail of the streamer) for different values of EI, T, and U₀ are plotted versus their corresponding frequencies, as illustrated in FIG. 4, it is noted that the velocity model is dispersive over the entire frequency band. However, at low frequencies, the velocity can be considered as approximately constant for the band 440 as the solid lines 410, 420 and 430, can be considered approximately equal to the non-dispersive models represented by dotted lines 412, 422, and 432. Thus, band 440 corresponds to the non-dispersive band. Note that lines 410 and 420 are described by equation (5) for T=20 kN, EI=50 Nm², and U₀=2 m/s while lines 412 and 422 are described by the same equation, but the bending stiffness product EI was set to be zero. Lines 430 and 432 correspond to the model when the water speed U₀ is set to zero. In one application, lines 412 and 422 can be calculated based on equations (7) and (8) of [1] for EI=0 and

$$T ≫ \frac{σ {U}_{0}^{2}}{2} ,$$

line 430 can be calculated based on equation (3) of [1] for U₀=0, when equation (3) is expressed as a function of the pulsation and not the wave number, and line 432 can be calculated based on equation (4) in [1] for U₀=0 and EI=0.

Lines 430 and 432 are in particular representative for not-towed cables, like a cable of a cable-stayed bridge, wherein the speed of the cable, namely the waveguide for transverse waves, in the medium in which it evolves is null: U₀=0.

As can be seen in FIG. 4, the velocity model is dispersive over the entire frequency band. However, at low frequencies, the velocity can be considered as approximately constant. According to an embodiment, the aim is to find the largest possible frequency band 440 for which the approximation is realistic, namely with the determination of the critical frequency f_{c} below which the estimated tension of the cable is most accurate. One solution to this problem, as detailed below, is to use the relative error e between the phase velocity vₚ and the non-dispersive velocity c.

For simplification of the notation below, the case where U₀=0 (curve 430), and a normalization with respect to the non-dispersive velocity c is considered. The relative error e is thus defined as:

$$e = \frac{{v}_{p} - c}{c} = \frac{γ \cdot c - c}{c} = γ - 1 \qquad ( 10 )$$

For curves 410 and 420, equation (10) can be rewritten as:

$$e = \frac{{v}_{p , \pm } - ( \pm c - \frac{{U}_{0}}{2} )}{\pm c - \frac{{U}_{0}}{2}} = \frac{\pm c γ - \frac{{U}_{0}}{2} - ( \pm c - \frac{{U}_{0}}{2} )}{\pm c - \frac{{U}_{0}}{2}} = \frac{γ - 1}{1 \pm \frac{{U}_{0}}{2 \cdot c}} \approx γ - 1 ( as c ≫ \frac{{U}_{0}}{2} ) \qquad ( 11 )$$

indicating a same order of magnitude, and a normalization with respect to the dispersive velocity vₚ would lead to an almost identical error as long as the error is small, i.e.,

$$e = \frac{{v}_{p} - c}{{v}_{p}} = \frac{γ \cdot c - c}{γ c} = \frac{γ - 1}{γ} \approx γ - 1 ( for γ \approx 1 ) \qquad ( 12 )$$

The relative error e can be rewritten, based on a Taylor series expansion of order 2 for γ as

$$e = γ - 1 = \frac{EI {σω}^{2}}{{T}^{2}} , \qquad ( 13 )$$

which corresponds to the critical frequency:

$${f}_{c} = \frac{{ω}_{c}}{2 π} = \frac{T}{2 π} \sqrt{\frac{e}{EI \cdot σ}} . \qquad ( 14 )$$

The choice of the maximum relative velocity error e gives the maximum critical frequency. For example, an error e of 1%, i.e., e= 1/100, gives good results, namely allows to obtain a frequency band wide enough to obtain a good estimation of the velocity when the tension is low (streamer tail) while ensuring a low error. Other values may be chosen as desired, based on the practical application. When using this selected value, the critical frequency is given by:

$${f}_{c} = \frac{{ω}_{c}}{2 π} = \frac{T}{20 π \sqrt{EI \cdot σ}} . \qquad ( 15 )$$

Because the critical frequency f_{c} depends on the tension T, in one embodiment, the method implements an iterative process, with a first estimation of the critical frequency based on a low-pass filtering of the data obtained from the particle motion sensors distributed along the streamer, for estimating a tension, using, for example, the formalism in [1] (for example, equation

$$T = π {{ρ}_{a} ( \frac{d}{2} {v}_{p} )}^{2} , \qquad ( 16 )$$

where ρₐ is the effective density of the streamer, i.e., ρₐ=ρₛ+ρ_{w}), and then the obtained tension is used in equation (15) for updating the critical frequency. The data obtained from the sensors is called herein “measured data,” and it may include an amplitude and phase of the displacement, velocity or acceleration of the sensor relative to a fix reference system.

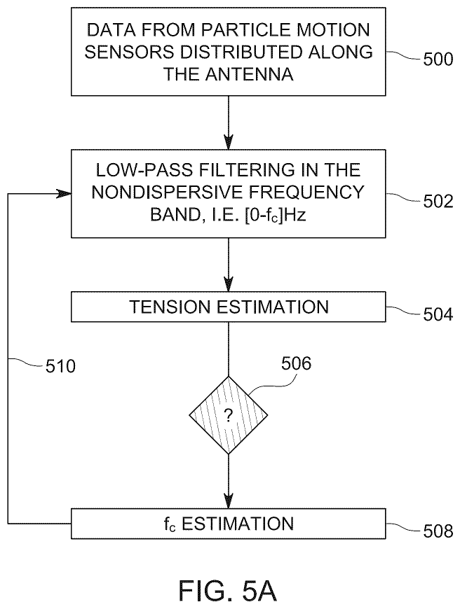

More specifically, as shown in FIG. 5A, the novel method starts in step 500 with receiving measurements (measured data) from the sensors (for example, particle motion sensors) distributed along the streamer (or antenna, or cable, etc.). This data may be acquired in a discrete manner, with any desired time period, or continuously. The data is received at a processing device, for example, a computer, processor, controller, etc., which is discussed later. The processing device may be located next to the streamer or remotely.

In step 502, a low-pass filtering is used for calculating the tension T, from the data measured by the sensors distributed along the cable/streamer, for example, based on equation (16) in [1]. The low-pass filtering is performed in the non-dispersive frequency band, which may have any value, for example 0-5 Hz, or 0-10 Hz or 0-15 Hz. The top value of the band is considered to be the critical frequency f_{c}. Note that the value of the critical frequency is not accurately determined in [1], but rather this value is selected based on experience. In fact, the value of the critical frequency at this step is empirical, and that is the problem with the existing algorithms. Based on this initial critical frequency and implicitly based on the calculated initial tension T, the method determines in step 504 the tension in the streamer, for example, based on equation (15). Other equations may be used for this step. The estimated tension Tis also not very accurate at this step as the value of the critical frequency was not accurate. Note that equation (16) is used to initially calculate the tension T, after which equation (15) is used exclusively to update the tension and the associated critical frequency.

Thus, in step 506, the method estimates whether the value of estimated tension is improving or not. This step can calculate a difference between the previously calculated tension and the current tension and if the difference is below a desired limit or threshold, the process stops and simply estimates the final critical frequency in step 508, also based on equation (15). However, if the difference is above the threshold, the process returns in step 510 to step 502 and repeats the estimation of the tension and critical frequency. These steps are repeated until the difference is below the desired value. Note that when step 502 is performed the second time, the value of the critical frequency in the initial non-dispersive frequency range is updated with the value calculated in step 508, and thus, the low-pass filtering step of the data from step 502 produces a different result, which also changes the new tension estimate performed in step 504.

The process illustrated in FIG. 5A may be modified as shown in FIG. 5B so that step 506 is performed after step 508. This means that the method estimates a difference between the previous and current critical frequencies and this difference should be less than a desired value to stop the process.

As shown in FIGS. 5A and 5B, the tension allows to estimate the critical frequency, which allows to filter the data in the non-dispersive band, which allows to obtain a new and more precise tension estimation. The latter allows the method to estimate a new criterion frequency and the method iterates the process until convergence is achieved. The criterion can be on the non-evolution of the tension (FIG. 5A) or the critical frequency (in FIG. 5B) or on the number of iterations (for both figures) or on any other criterion which shows that there is convergence of the method. In practice, the inventor has observed that a few iterations (2 or 3) are necessary for convergence. The method can be initialized from a fixed frequency band, e.g., [0-15] Hz as described in [1], or from a knowledge of the mechanical tension obtained by another means, auxiliary sensor for example.

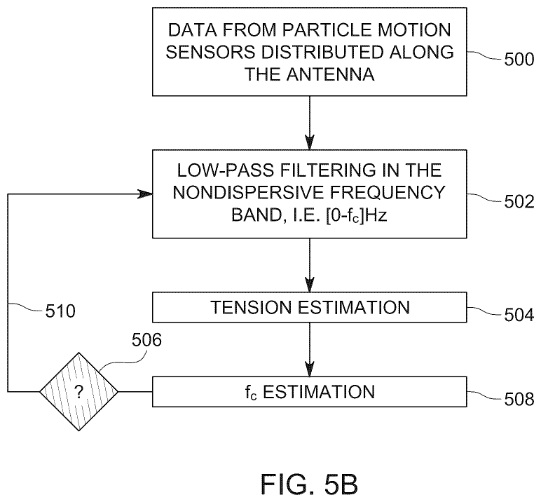

Because the distance between the sensors in a streamer is perfectly known, the group velocity of the wave along the streamer is known. For other cables, which are not implicitly containing such distributed sensors, the methods discussed above can be implemented by placing suitable sensors at known locations, an illustration thereof being illustrated in FIG. 6. This figure shows a bridge 600 having plural cables 610 that support a deck 612. A distance D between plural sensors 620 (for example, accelerometers) is known for this case. For some shorter static cables, like for bridges or other buildings, it is possible to assume that the tension is constant all along the cable. Two sensors separated by a precisely known distance are thereby sufficient to perform the process according to the method of FIGS. 5A and 5B.

As noted above, although the embodiments were discussed for transverse waves in a streamer, the methods discussed herein equally apply to longitudinal waves in any structure that may experience stress, for example, compression waves in a beam. While the methods discussed above used the tension as the parameter to be monitored, other parameters may also be monitored, for example, the Young modulus, stress, deformation, i.e., any parameter that is linked to the velocity though a model or equation in a non-dispersive band. In one application, within the framework of the model developed for the transverse waves, it is possible to estimate the linear mass of the cable provided that the mechanical tension is known. In another application, by using another model, it is possible to estimate other parameters, such as the length of the cable, the linear mass, the bending stiffness EI, etc.

The phase velocity vₚ may be calculated as now discussed. Because the sensors are usually uniformly spatially sampled (they are uniformly distributed along the streamer), it is possible to compute the phase velocity by estimating the time delay between adjacent particle motion sensors within a streamer and then divide an offset between the adjacent sensors with the time delay. In other words, if a transverse vibration propagates along the streamer, it will first affect particle motion sensor Sᵢ and then the particle motion sensor Sin. Because the particle motion sensors record the transverse movement of the streamer, it is possible from these two recordings, to extract the time tᵢ when Sᵢ measured first the vibration and the time tin when Sin measured second the same vibration. The time difference tᵢ₊₁−tᵢ represents the time delay of the vibration. In this regard, there are several techniques (e.g., generalized cross correlation) in time or frequency domain that can be used to estimate the time delay between adjacent channels. Knowing the distance D (usually 12.5 m) between adjacent sensors Sᵢ and Sᵢ₊₁, the value of the phase velocity may be determined.

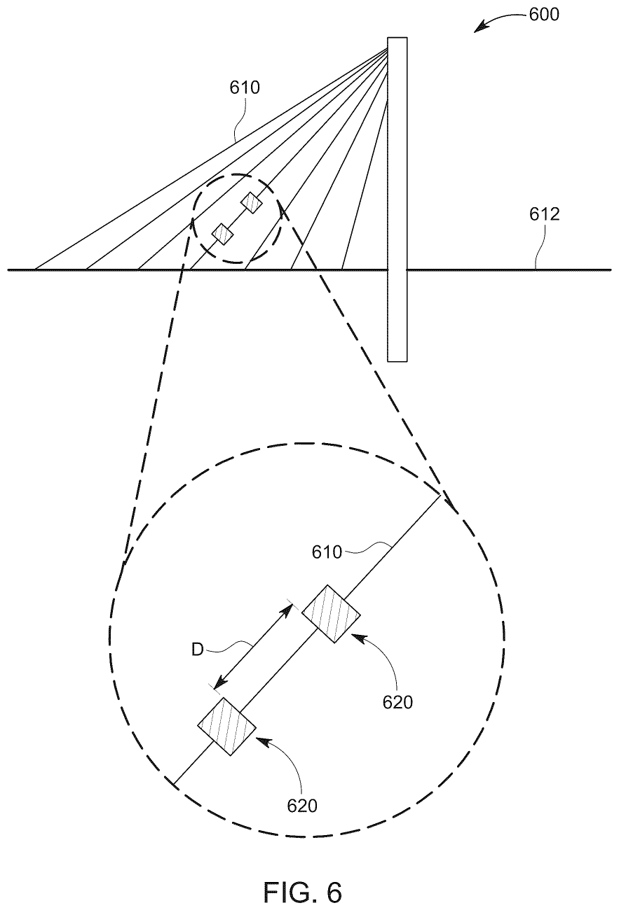

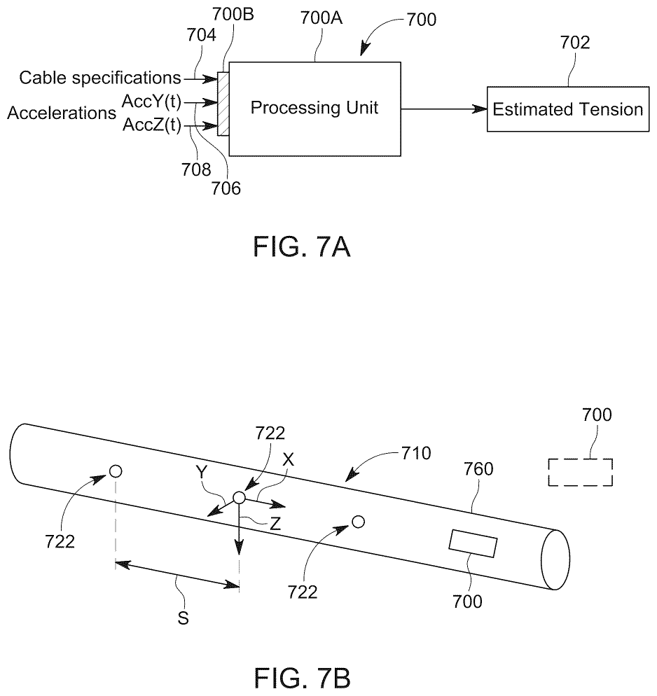

The methods discussed above may be implemented, for example, as illustrated in FIG. 7A, in a computing device 700, which includes a processing unit 700A and an interface 700B. The inputs used for calculating the tension output 702 are: the tensionable element's specifications 704 (e.g., diameter, density, length), and the accelerations or velocities or displacements 706 and 708 along two axes perpendicular to the length of the cable. FIG. 7B shows a portion of a tensionable element (e.g., cable or antenna or streamer) 710 having a body 760 within which plural particle motion sensors (PMS) 722 are located. The PMS 722 are linked to the computing device 700, which may be the device discussed above with regard to FIG. 7A. The figure shows only three particle motion sensors 722 distributed with a predetermined space S. FIG. 7B also indicates the inline direction X along the length of the tensionable element, the cross-line direction Y, which is perpendicular to the inline indirection, and a third direction Z, which is perpendicular on both the X and Y directions. While FIG. 7B shows the computing device 700 located within the streamer, one skilled in the art would understand that computing device may also be located outside the streamer, especially when the method is applied to a cable of a bridge, which cannot accommodate the device 700.

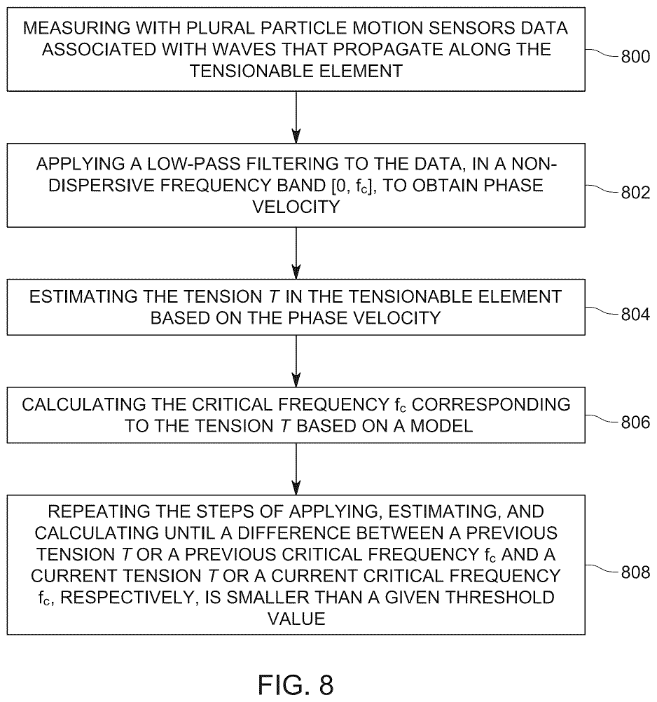

A flowchart of a method for monitoring the tension in the streamer (antenna) discussed above is now presented with regard to FIG. 8. Note that the embodiments discussed above apply to any cable towed in water and having particle motion sensors within or attached to the body of the antenna, or any stationary cable used in industrial, residential or commercial buildings or structure, e.g., bridges.

The method includes a step 800 of measuring with plural particle motion sensors data associated with waves that propagate along the tensionable element, a step 802 of applying a low-pass filtering to the data, in a non-dispersive frequency band [0, f_{c}], to obtain a phase velocity, which is considered to be equal to the group velocity in the non-dispersive frequency band, a step 804 of estimating the tension T in the tensionable element based on the calculated phase velocity, a step 806 of calculating the critical frequency f_{c}, corresponding to the tension T, based on a model that links the critical frequency to the tension, and a step 808 of repeating the steps of applying, estimating, and calculating until a difference between a previous tension Tor a previous critical frequency f_{c} and a current tension T or a current critical frequency f_{c}, respectively, is smaller than a given threshold value. The critical frequency f_{c} defines a border between the non-dispersive frequency band and a dispersive frequency band of the tensionable element.

The method may further include selecting a value for a relative error e between (1) a non-dispersive velocity c of the waves along the tensionable element and (2) a dispersive velocity vₚ of the waves along the tensionable element, and establishing the model based on the value of the relative error e, the critical frequency f_{c}, the tension T, a Young modulus of the tensionable element, an area moment of inertia of the tensionable element, and a mass of the tensionable element per unit of length.

In one application, the critical frequency f_{c} is proportional to the tension T and inverse proportional to a square root of a product of (1) the Young modulus of the tensionable element, (2) the area moment of inertia of the tensionable element, and (3) the mass of the tensionable element per unit of length. The model is given by

$${f}_{c} = \frac{T}{20 π \sqrt{EI \cdot σ}} .$$

The step of applying may include calculating a value of a phase velocity vₚ of the vibrations that propagate along the tensionable element based on (1) an offset between two particle motion sensors, and (2) a time delay of the vibrations that propagate from one of the two particle motion sensors to another one of the two particle motion sensors. The step of estimating may include calculating the tension T based on the phase velocity vₚ. The step of estimating may further include calculating the tension T for an updated value of the critical frequency. The data is seismic displacement or velocity data associated with the tensionable element under the tension. One or more of the above methods may be implemented in the processing unit 700 of FIG. 7A. In one application, the processing unit 700 is the navigation system of the vessel shown in FIG. 1.

As will be appreciated by one skilled in the art, the above discussed embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized, including hard disks, CD-ROMs, digital versatile discs (DVD), optical storage devices or magnetic storage devices such a floppy disk or magnetic tape. Other non-limiting examples of computer-readable media include flash-type memories or other known types of memories.

The disclosed exemplary embodiments provide a method for jointly estimating a tension in a cable and a critical frequency which defines a non-dispersive frequency range. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

For example, for Structural Health Monitoring wherein the vibrations might be small, the method discussed above can be associated with an active vibration monitoring for either obtaining a passive audit, namely checking the ambient vibrations, or for obtaining an active audit, i.e., applying an external excitation on the cable and then measuring the parameters discussed above.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] U.S. Pat. No. 10,371,840.
[2] E. Caetano, part 3.3 “New approach for damage assessment in cables” in “Characterization and assessment of damage in cable structures”; J Civil Struct Health Monit (2022). doi.org/10.1007/s13349-022-00614-z.
[3] V. Smirnov, A. Sourice, J. Ribette, J. Mars, and P. Herrmann, 2022, Characterization and simulation of transverse noise waves of a multisensor solid streamer, SEG Technical Program Expanded Abstracts: 95-99.

What is claimed is:

1. A method for jointly estimating a tension T and a critical frequency f_{c} in a tensionable element, the method comprising:
measuring with plural particle motion sensors data associated with waves that propagate along the tensionable element;
applying a low-pass filtering to the data, in a non-dispersive frequency band [0, f_{c}], to calculate a phase velocity of the wave;
estimating the tension Tin the tensionable element based on the phase velocity of the wave;
calculating the critical frequency f_{c} corresponding to the tension T based on a model which links the critical frequency to the tension; and
repeating the steps of applying, estimating, and calculating until a difference between a previous tension Tor a previous critical frequency f_{c} and a current tension T or a current critical frequency f_{c}, respectively, is smaller than a given threshold value,
wherein the critical frequency f_{c} defines a border between the non-dispersive frequency band and a dispersive frequency band of the tensionable element.

2. The method of claim 1, further comprising:
selecting a value for a relative error e between (1) a non-dispersive velocity c of the wave along the tensionable element and (2) a dispersive velocity vₚ of the wave along the tensionable element; and
establishing the model based on the value of the relative error e, the critical frequency f_{c}, the tension T, a Young modulus of the tensionable element, an area moment of inertia of the tensionable element, and a mass of the tensionable element per unit of length.

3. The method of claim 1, wherein the model has the critical frequency f_{c} being proportional to the tension T and inverse proportional to a square root of a product of (1) the Young modulus of the tensionable element, (2) the area moment of inertia of the tensionable element, and (3) the mass of the tensionable element per unit of length.

4. The method of claim 1, wherein the model is given by
$${f}_{c} = \frac{T}{2 π} \sqrt{\frac{e}{EI \cdot σ}} ,$$
where e is a relative error between (1) a non-dispersive velocity c of the wave along the tensionable element and (2) a dispersive velocity vₚ of the wave along the tensionable element, E is a Young modulus of the tensionable element, I is an area moment of inertia of the tensionable element, and o is a mass of the tensionable element per unit of length.

5. The method of claim 1, wherein the step of applying comprises:
calculating a value of the phase velocity vₚ of the wave that propagates along the tensionable element based on (1) an offset between two particle motion sensors, and (2) a time delay of the vibrations that propagate from one of the two particle motion sensors to another one of the two particle motion sensors.

6. The method of claim 1, wherein the step of estimating comprises:
calculating the tension T based on the phase velocity vₚ calculated within the non-dispersive frequency range.

7. The method of claim 6, wherein the step of estimating further comprises:
calculating the tension T for an updated value of the critical frequency.

8. The method of claim 1, wherein the data is seismic data.

9. A computing device for jointly estimating a tension T and a critical frequency f_{c} in a tensionable element, the computing device comprising:
an interface for receiving data measured with plural particle motion sensors along the tensionable element, wherein the data is associated with waves that propagate along the tensionable element; and
a processor connected to the interface and configured to,
apply a low-pass filtering to the data, in a non-dispersive frequency band [0, f_{c}], to obtain a phase velocity of the wave;
estimate the tension Tin the tensionable element based on the phase velocity of the wave;
calculate the critical frequency f_{c} corresponding to the tension T based on a model which links the critical frequency to the tension; and
repeat the steps of applying, estimating, and calculating until a difference between a previous tension Tor a previous critical frequency f_{c} and a current tension T or a current critical frequency f_{c}, respectively, is smaller than a given threshold value,
wherein the critical frequency f_{c} defines a border between the non-dispersive frequency band and a dispersive frequency band of the tensionable element.

10. The computing device of claim 9, wherein the processor is further configured to:
select a value for a relative error e between (1) a non-dispersive velocity c of the wave along the tensionable element and (2) a dispersive velocity vₚ of the wave along the tensionable element; and
establish the model based on the value of the relative error e, the critical frequency f_{c}, the tension T, a Young modulus of the tensionable element, an area moment of inertia of the tensionable element, and a mass of the tensionable element per unit of length.

11. The computing device of claim 9, wherein the model has the critical frequency f_{c} being proportional to the tension T and inverse proportional to a square root of a product of (1) the Young modulus of the tensionable element, (2) the area moment of inertia of the tensionable element, and (3) the mass of the tensionable element per unit of length.

12. The computing device of claim 9, wherein the model is given by
$${f}_{c} = \frac{T}{2 π} \sqrt{\frac{e}{EI \cdot σ}} ,$$
where e is a relative error between (1) a non-dispersive velocity c of the wave along the tensionable element and (2) a dispersive velocity vₚ of the wave along the tensionable element, E is a Young modulus of the tensionable element, I is an area moment of inertia of the tensionable element, and o is a mass of the tensionable element per unit of length.

13. The computing device of claim 9, wherein the processor is further configured to:
calculate a value of the phase velocity vₚ of the wave that propagate along the tensionable element based on (1) an offset between two particle motion sensors, and (2) a time delay of the vibrations that propagate from one of the two particle motion sensors to another one of the two particle motion sensors.

14. The computing device of claim 9, wherein the processor is further configured to:
calculate the tension T based on the phase velocity vₚ calculated within the non-dispersive frequency range.

15. The computing device of claim 14, wherein the processor is further configured to:
calculate the tension T for an updated value of the critical frequency.

16. The computing device of claim 9, wherein the processor is further configured to:
calculate a parameter of the tensionable element which is linked to the tension T in said tensionable element.

17. A streamer to be towed in water for collecting seismic data, the streamer comprising:
a body;
plural particle motion sensors located inside the body; and
a computing device located inside the body, the computing device including,
an interface for receiving data measured with plural particle motion sensors along the tensionable element, wherein the data is associated with waves that propagate along the tensionable element; and
a processor connected to the interface and configured to,
apply a low-pass filtering to the data, in a non-dispersive frequency band [0, f_{c}], to calculate a phase velocity of the wave;
estimate the tension T in the tensionable element based on the phase velocity of the wave;
calculate the critical frequency f_{c} corresponding to the tension T based on a model which links the critical frequency to the tension; and
repeat the steps of applying, estimating, and calculating until a difference between a previous tension Tor a previous critical frequency f_{c} and a current tension T or a current critical frequency f_{c}, respectively, is smaller than a given threshold value,
wherein the critical frequency f_{c} defines a border between the non-dispersive frequency band and a dispersive frequency band of the tensionable element.

18. The streamer of claim 17, wherein the processor is further configured to:
select a value for a relative error e between (1) a non-dispersive velocity c of the wave along the tensionable element and (2) a dispersive velocity vₚ of the wave along the tensionable element; and
establish the model based on the value of the relative error e, the critical frequency f_{c}, the tension T, a Young modulus of the tensionable element, an area moment of inertia of the tensionable element, and a mass of the tensionable element per unit of length.

19. The streamer of claim 18, wherein the model has the critical frequency f_{c} being proportional to the tension T and inverse proportional to a square root of a product of (1) the Young modulus of the tensionable element, (2) the area moment of inertia of the tensionable element, and (3) the mass of the tensionable element per unit of length.

20. The streamer of claim 18, wherein the model is given by
$${f}_{c} = \frac{T}{2 π} \sqrt{\frac{e}{EI \cdot σ}} ,$$
where e is a relative error between (1) a non-dispersive velocity c of the wave along the tensionable element and (2) a dispersive velocity vₚ of the wave along the tensionable element, E is a Young modulus of the tensionable element, I is an area moment of inertia of the tensionable element, and o is a mass of the tensionable element per unit of length.
